(19) United States
(12) Patent Application Publication
(10) Pub. No.: US 2005/0115979 A1
(43) Pub. Date: Jun. 2, 2005

(54) Dispenser and roll for absorbent articles

(75) Inventors: Jeanette Hellstrom, Goteborg (SE); Berit Rosseland, Vallda (SE); Britt-Marie Wiezell, Molnlycke (SE); Mathias Mjolner, Goteborg (SE)

Correspondence Address: BURNS DOANE SWECKER & MATHIS L L P, POST OFFICE BOX 1404, ALEXANDRIA, VA, 22313-1404, US

(73) Assignee: SCA Hygiene Products AB, Goteborg (SE)

(21) Appl. No.: 10/998,055

(22) Filed: Nov. 29, 2004

Related U.S. Application Data
(60) Provisional application No. 60/525,171, filed on Nov. 28, 2003.

(51) Int. Cl. G07F 11/66; B65H 5/28

(52) U.S. Cl. 221/25; 221/73

(57) ABSTRACT

A dispenser (11) for absorbent articles (14) containing adhesive coating on one side only, the articles being adhered in a longitudinal array to an elongate web (15) of release material. The dispenser has a housing including a device for supporting the package of absorbent articles. The housing (12) contains a device (16,17) for delivering absorbent articles from the package (13) of absorbent articles to an outlet (18) for absorbent articles in the housing, a device (19) for separating absorbent articles from the web of release material and a device (17) for storing the portion of web of release material, from which absorbent articles has been separated, the separating device being arranged in connection to the outlet. A roll (13) of absorbent articles (14) is used in such a dispenser.

### CROSS-REFERENCE TO RELATED APPLICATIONS

The present application claims the benefit of U.S. Provisional Application No. 60/525,171, filed in the United States on Nov. 28, 2003, the entire contents of which are hereby incorporated herein by reference.

### TECHNICAL FIELD

The present invention relates to a dispenser for absorbent articles in the form of sanitary napkins, interlabial products, baby diapers or incontinence protectors containing adhesive coating on one side only. The invention also relates to a roll of absorbent articles for use in such a dispenser.

### BACKGROUND OF THE INVENTION

In order to enable a user of sanitary napkins or the like to bring with her a daily supply of sanitary napkins in a handbag or the like, the sanitary napkins are often packaged in individual packages. However, for several reasons a need for a sanitary napkin may unexpectedly arise and there is therefore a need for having supplies of such articles available in public services, in public toilets in warehouses or the like, in hospitals, in pubs and restaurants, in hotels, in airports, in air-planes, busses and trains, in offices, etc. This need has to some extent been solved by coin actuated vending machines containing individually packaged sanitary napkins or tampons. Such vending machines are quite complicated and the filling of products into the machine is quite time-consuming. Vending machines are also expensive and are placed outside the toilets to be accessible to all. Moreover, since the machine itself protects the products from environmental contamination, it is a waste of packaging material to have the products individually packaged. There is therefore a need for dispensers of sanitary napkins or the like which are of a simple construction and in which the sanitary napkins are stored without being individually packaged. Such dispensers should also be so cheap to manufacture that they can be placed in every toilet.

WO 99/26576 discloses a dispenser for interlabial devices which is of simple construction. The interlabial devices are arranged as a continuous array of individually packaged devices joined together by frangible connections. With such a dispenser the problem of disposing the packages for the interlabial devices remains and it is stated that this dispenser may also comprise a case for dispensing these packages. Such a dispenser is not suitable to use in public services or the like since there is nothing to prevent a person from taking all of the interlabial devices out of the dispenser and bringing the devices with her for later private use.

US-B1-6,254,582 discloses a supply of panty liner pads formed by a continuous longitudinal array of pad segments forming a strip. The strip has locally weakened zones to facilitate tearing off segments from the strip without the use of a cutting tool. The strip is wrapped upon itself into a roll so that pressure sensitive positioning adhesive strips are placed into contact with release surfaces formed on the strip, thereby protecting the adhesive prior to use without the need for release paper. Such a roll is not suitable to use in a dispenser provided in public services or the like since the idea behind this roll is to enable the user to take more than one segments at a time from the roll. Accordingly, there is nothing to prevent a person from taking all of the pad segments out of such a dispenser and bringing the segments with her for later private use.

### OBJECTS AND SUMMARY

An objective of the present invention is to provide a dispenser for absorbent articles in the form of sanitary napkins, interlabial products, baby diapers or incontinence protectors, which dispenser is of simple construction and which discourages a user from taking out more articles from the dispenser than is necessary for the immediate need of the user. Another objective is to make the dispenser suitable for dispensing articles from a roll of such articles, in which the articles lack individual packages.

One embodiment for accomplishing these objectives includes a dispenser for absorbent articles in the form of sanitary napkins, panty liners, interlabial products, baby diapers or incontinence protectors containing adhesive coating on one side only, the articles being adhered in a longitudinal array to an elongate web of release material, which is rolled or folded into a package of absorbent articles, the dispenser has a housing including means for supporting the package of absorbent articles, wherein the housing contains means for delivering absorbent articles from the package of absorbent articles to an outlet for absorbent articles in the housing, means for separating absorbent articles from the web of release material and means for storing the portion of web of release material, from which absorbent articles has been separated, the separating means being arranged in connection to the outlet. Due to the fact that the web of release material is contained in the housing only absorbent articles without a protective layer on the adhesive coating or coatings are delivered outside the housing of the dispenser. Such articles are not easy for a person to bring with her/him since the strong adhesive easily fastens to surrounding surfaces or to itself, thereby impairing or destroying the function of the article. The likelihood that a person will take more articles out of the dispenser than needed for immediate use is therefore small. Another advantage is that the user does not have to dispose of release material. The storage of release material inside the housing also makes the disposal thereof very efficient compared to the disposal of individual pieces of release material present on individually packaged articles.

In a preferred embodiment, the means for delivering absorbent articles are means for unwinding a roll of absorbent articles, the roll being formed by the web being wrapped upon itself into a roll of absorbent articles. Furthermore, means for activating the unwinding means is preferably disposed on the outside of the housing. The means for storage of the web of release material is preferably a storage roller onto which the portion of web of release material, from which absorbent articles has been separated, is winded, wherewith the means for unwinding the roll of absorbent articles is means for winding up the portion of web of release material, from which absorbent articles has been separated, onto the storage roller. Preferably, the dispenser comprises means for obstructing unwinding of the storage roller.

The means for separating absorbent articles from the web of release material comprises a web guide element changing the path of the web so that an angle is formed between the portion of the path of the web, situated between the roll of absorbent articles and the guide element, and the portion of the path of the web situated between the guide element and the storage roller and the outlet for absorbent articles is disposed in line with the direction of the path of the web of release material before reaching the web guide element. The angle is preferably acute.

The web guide element is preferably a roller and a separating element can be disposed adjacent to the web guide element between the portion of the path of the web, situated between the guide element and the storage roller, and a plane coincidental to the direction of the path of the web of release material before reaching the web guide element. The separating element is a roller or a blade, which to advantage is disposed and dimensioned to pass between longitudinal stripes of adhesive coatings on the absorbent articles.

An embodiment of the invention also includes a roll of absorbent articles in the form of sanitary napkins, interlabial products, baby diapers or incontinence protectors containing adhesive coating on one side only, wherein it comprises an elongate web of release material to which the articles are adhered in a longitudinal array, the web being wrapped upon itself into a roll of absorbent articles for use in a dispenser of the type stated above, and in that absorbent articles is absent on an outer end portion of the roll, the end portion being forward when unwinding the roll. Compared to individually packaged articles a lot of package material is saved by such a roll since much less package material is needed to cover the roll than would be needed if the articles in the array were to be individually packaged.

An embodiment of the invention also includes a package of absorbent articles in the form of sanitary napkins, interlabial products, baby diapers or incontinence protectors containing adhesive coating on one side only, characterised in that it comprises an elongate web of release material to which the articles are adhered in a longitudinal array, the web being zigzag folded into a package of stacked absorbent articles for use in a dispenser of the type stated above, and in that absorbent articles are absent on an outer end portion of the roll, the end portion being forward delivering absorbent articles from the package.

In a preferred embodiment, the absorbent articles are longitudinally spaced a small distance from each other in the longitudinal array and at least the forward end of each absorbent article can be free from adhesive coating.

### BRIEF DESCRIPTION OF THE DRAWINGS

Embodiments of the invention will now be described with reference to the enclosed figures, of which;

FIG. 1 shows a schematic plan view of a portion of a web of release material having a longitudinal array of sanitary napkins attached thereto according to a first preferred embodiment of the invention,

FIG. 2 shows a schematic plan view of a portion of a web of release material having a longitudinal array of sanitary napkins attached thereto according to a second preferred embodiment of the invention,

FIGS. 3 shows a sectional view along line III-III in FIG. 1,

FIG. 4 shows a sectional view along line IV-IV in FIG. 2,

FIG. 5 shows a side view of a dispenser according to a first preferred embodiment of the invention with one sidewall of the housing removed,

FIG. 6 shows a view similar to FIG. 5 of a dispenser according to a second embodiment of the invention, and

FIG. 7 shows a side view of a part of a dispenser according to a third embodiment of the invention.

### DESCRIPTION OF PREFERRED EMBODIMENTS

A web 1 of release material onto which a longitudinal array of sanitary napkins 2 is attached, is disclosed in FIGS. 1 and 3. Each sanitary napkin 2 comprises an absorbent body enclosed between two casing sheets, a liquid-permeable top sheet and a liquid impermeable backing sheet (not shown). Two longitudinal strings of pressure sensitive adhesive 3,4 are disposed on the backing sheet and the sanitary napkins in the array are attached to the web 1 by these adhesive strings 3,4. The strings of adhesive 3,4 do not extend over the whole length of the sanitary napkin but end a distance from each end of the sanitary napkin 2.

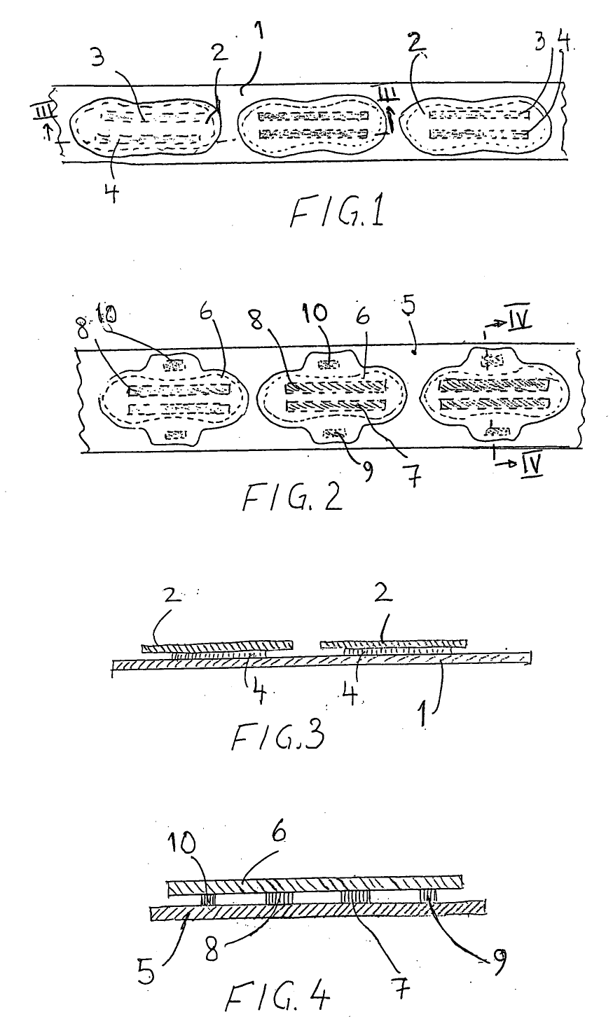

In FIGS. 2 and 4 a web 5 is shown onto which a longitudinal array of sanitary napkins or panty liners 6 are attached. The sanitary napkins 6 differ from the sanitary napkins 2 in that they comprise wings on both longitudinal sides of the napkins. These wings are to be folded around the edges of a pair of underpants in use and fastened to the outside thereof with the help of strings of adhesive 9,10. In all other respects the sanitary napkins 6 correspond to the napkins 2 shown in FIG. 1, the longitudinal strings of adhesive to be fastened to the inside of a pair of underpants are given the reference numerals 7,8.

The webs 1,5 of release material can be comprised of silicon coated paper. Other materials known to be used as release material for sanitary napkins or the like, such as plastic materials with an irregular surface, can of course also be used.

The top sheet of the sanitary napkin can be a nonwoven material or a perforated plastic material and the backing sheet can be a plastic material, preferably an air-permeable material. However, all material known to be used as top sheet or backing sheet material on sanitary napkins or absorbent articles can be used in the present invention.

The absorbent body of the sanitary napkin comprises preferably one or more layers of cellulose fluff with or without superabsorbent material mixed therein. Also other types of fibres, such as synthetic staple fibres, can be mixed with the cellulose fluff. Tissue layers and/or layers of wadding can also be comprised in the absorbent body.

The sanitary napkins described above are only given as examples. Any type of sanitary napkin or the like can be used in the present invention.

The sanitary napkins in the array are preferably spaced from each other by a small distance in the order of 10 mm.

After a longitudinal array of sanitary napkins or the like has been attached to the web of release material, the web is wrapped upon itself into a roll or zigzag folded into a package of sanitary napkins stacked on each other. In case of a folded package the distance between the napkins in the array should at least correspond to double the thickness of each napkin.

In FIG. 5, a first embodiment of a dispenser 11 according to the invention is schematically shown. In a housing 12, a roll 13 of sanitary napkins 14 attached in a longitudinal array to a web 15 of release material is rotatably supported. The sanitary napkins 14 and the web 15 in the roll can be similar to the examples shown in FIGS. 1 and 2. In such a roll sanitary napkins are absent in the outer end portion of the roll, i.e. the end portion being forward when the roll is unwinded. When the roll is placed within the dispenser 11, the outer end portion of the roll is brought around a guide roller 16 and the outermost end of the end portion is attached to the shaft of a storage roller 17 by suitable means. For example, the shaft of roller 17 can have a slot or groove into which the outermost end can be inserted. The roller 17 must be distanced from the guide roller 16 so by a distance of at least the radius of the storage roller when whole of the web 15 is wound up thereon and also from the periphery of roll 13 of sanitary napkins by a small distance. This distance can be quite small since the increase in diameter of the roller 17 during unwinding of the web 15 thereon is compensated by a decrease in diameter of the roll 13 which is of a greater magnitude. The outer end portion of the roll 13 without sanitary napkins shall have a length allowing its application around the guide roller 16 and its fastening to the storage roller 17 without any sanitary napkin 14 on the web 15 reaching the guide roller 16 during such an application. The length of the outer end portion of the roll 13 without sanitary napkins should at least exceed the length of a sanitary napkin 14.

Means to rotate the shaft of the roller (not shown) is present outside the housing. These means can be a simple handle for manual operation of the dispenser or a button for activating a motor, preferably a step motor.

The guide roller 16 is placed in such a relationship to the storage roller 17 and the roll 13 of sanitary napkins that the path of the web 15 is subjected to a marked change of direction when passing the guide roller 16. Preferably the angle α between the portions of the path of the web 15 immediately before and immediately after the passage of the guide roller 16 is acute.

The housing 12 has an outlet 18 for sanitary napkins which outlet is placed in line with the path of the web 15 immediately before the guide roller 16.

The sanitary napkins 14 are less flexible than the web 15 and when the web changes direction when passing the guide roller 16, the sanitary napkin fastened to the web has a tendency to maintain its direction of travel. Due to the low adhesion between the silicon coated web and the adhesive, the sanitary napkins come loose easily from the web. By rotating storage roller 17 in the direction indicated by an arrow in FIG. 5, the sanitary napkins 14 will be moved in a direction towards the outlet 18 and will also come loose from web 15 when passing roller 16. Thus, by rotating storage roller 17 sanitary napkins will be dispensed from the outlet 18.

In order to facilitate for the sanitary napkins to come loose from the web, a separator 19 is preferably disposed between the guide roller 16 and the outlet 18 outside of the line of travel for the sanitary napkins 14 and adjacent to the guide roller. In the embodiment according to FIG. 5, the separator is a small, rotatably supported roller 19 which is dimensioned and placed to pass between the strings of adhesive 3,4 or 7,8 of the sanitary napkins shown in FIGS. 1 and 2, respectively. Such a separator may be necessary if the sanitary napkins are so flexible that they tend to follow the line of travel of the web at the place for the guide roller instead of coming loose from the web. For such sanitary napkins it is important that the strings of adhesive do not reach the forward end seen in the direction of travel so that at least this end of the sanitary napkin will pass the guide roller 16 without changing its direction of travel. It is of course possible to provide two or more such separators co-operating with longitudinal regions on the sanitary napkins free from adhesive coating.

If the sanitary napkins on the web have adhesive coating over whole or most of its surface, the peripheral surface of the separator 16 has preferably a coating of a material with low adhesion to such an adhesive coating, for example silicon or Teflon®.

The storage roller 17 is preferably only rotatable in the direction indicated by an arrow in FIG. 5. This can be accomplished in any suitable way. For example, a manually operated handle can be connected to the shaft of the storage roller by a one-way clutch or the shaft can have a serration co-operating with one or more spring actuated stop elements, in one direction intervening with radial faces of the teeth preventing rotation of the shaft, in the other direction riding on curved peripherally directed faces of the teeth.

In order to prevent slacking of the web due to the inertia of the roll 13, a tension device 20 in form of a spring-actuated roller 21 is attached to the housing 12. Another way of counteracting inertial forces is to support the shaft of roll 13 in frictional bearings. A slack of the web 15 can also occur if a user does not use the handle for taking out a sanitary napkin but stops the rotation of the shaft of roller 17 as soon as the forward end of a sanitary napkin protrude out of the outlet 18 and then pulls the rest of the sanitary napkin out by hand. In order to take care of such an eventuality, the storage roller can preferably be spring-loaded to rotate when the web becomes tensionless. Another way would be to provide a tension device similar to tension device 20 in the path of the web between guide roller 16 and storage roller 17, the stroke of which should correspond to the length of a sanitary napkin 14.

Optionally, a roller 22 for delivering a skin caring substance, such as lactobacilli, antiseptic compounds, ointments, creams, plant extracts or sweet-scented substances, to the adhesive free liquid-permeable top sheet is disposed within the housing. This roller can dip into a bath of the substance in question. Another possibility is to make the roller of a foam material in which the skin caring substance can be stored before being delivered. A counter pressure roller can be provided opposite roller 22. It is also, possible to deliver sweet-scented substances to the backing sheet with aid of the separator roller 19, which in such a case could be made of a foam material and be disposed so that it is in contact with the backing sheet.

In order to make it possible to change the roll 13 of sanitary napkins and fill the bath of skin caring substance co-operating with roller 22, one side wall or the top wall of the dispenser removably affixed to the rest of the housing 12, for example hinged to the rear wall of the housing. Furthermore, the housing 12 or part thereof is preferably transparent so that it is possible to see if a change of roll 13 is necessary without having to open the housing.

The dispenser 11 has several advantages. The user does not have to dispose of the release material since all release material is stored in the dispenser. There is thus no risk for release material to flushed down in the toilet or pieces of release material to be mixed together with used paper towels or the like. Furthermore, it is unlikely that a person uses more sanitary napkins than is needed for the moment, since the adhesive coating of the napkins easily attach to clothing or other surfaces or materials. If a person brings with her napkins from the dispenser, these napkins will be soiled and probably unable to use due to the unprotected adhesive coating being contaminated or destroyed. It is thus possible for a restaurant or the like to offer sanitary napkins as a free service without risk for “theft” of the napkins. If the storage roller 17 is spring loaded to rotate in the winding up direction there is neither no risk that slackened web 15 will protrude out of the outlet 18 and thereby be available to a user.

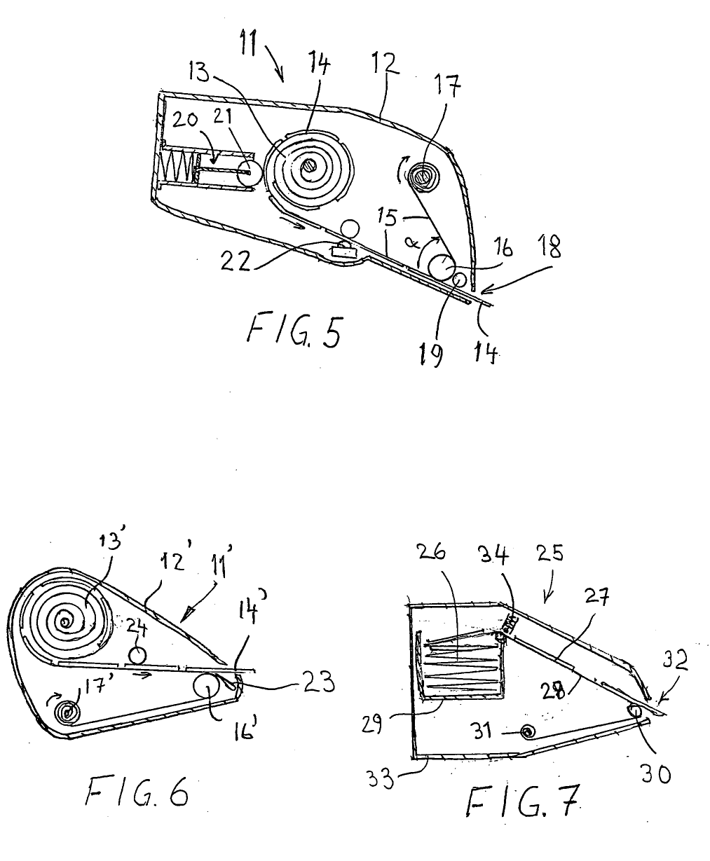

In FIG. 6, a second embodiment of a dispenser 11′ is shown. This dispenser is in many respects similar to the dispenser 11 in FIG. 5 and corresponding components have been given the same reference numeral with the addition of a prime sign. The roll 13′ differs from the roll 13 in the embodiment shown in FIG. 1 in that it is rolled in the opposite direction so that the sanitary napkins 14′ are attached to the radially inner side of the web 15′ instead of the radially outer side. In order to give the sanitary napkins 14′ a free path to the outlet 18′ the storage roller 17′ is placed on the opposite side of the outlet 18′ as the roll 13′. The main difference between the dispenser 11′ and the dispenser 11 shown in FIG. 5 is that the separator 23 in the second embodiment has the form of a blade. Such a blade-formed separator is suitable to use if the sanitary napkins 14′ are thin and very flexible, thereby having a tendency to follow the web 15′ around the periphery of the guide roller 16′. Moreover, a support roller 24 ensures that sanitary napkins 14′ will follow the same line of travel from the guide roller 16′ and to the outlet independent on the decreasing diameter of the roll 13′ subsequent to the unwinding thereof. Such a support roller is preferably also present in the dispenser according to FIG. 5 if a counter pressure roller opposite roller 22 is missing. In all other respects the dispenser 11′ is similar to dispenser 11 shown in FIG. 5.

Both of the rolls 13, 13′ preferably contain also a web portion lacking sanitary napkins in the rear end portion as seen in the direction of unwinding. The rear end portion of the web should have such a length that at least the forward end of the last sanitary napkin on the web reaches the outlet of the dispenser before the web loosens from the shaft supporting the roll 13,13′ during unwinding thereof. By such a construction it is ensured that the web is hold under tension during deliverance of all sanitary napkins attached thereto.

The forward end portion of the web 15 or 15′ functions as a protection for sanitary napkins 14,14′ after the web has been wrapped upon itself to form the roll 13, 13′. It is thus not necessary to put the rolls 13, 13′ into a transport package in order to protect the sanitary napkins from contamination. For the embodiment shown in FIG. 5, the outer end portion of the roll 13 without sanitary napkins should thus have a length corresponding to or exceeding the length of the periphery of a full roll 13.

In FIG. 7 a dispenser 25 for dispensing a package 26 of sanitary napkins 27 attached to a web 28, which has been zigzag folded to form a stack of sanitary napkins, is shown. Also in this case the forward and rear end portions of the web are without sanitary napkins 27. The package 26 is disposed in a receptacle 29 and the forward end portion of the web 28 is brought around a guide roller 30 and fastened to the shaft of a storage roller 31. The receptacle 29 and the rollers 30,31 are supported in a housing 33 having an outlet 32 for sanitary napkins 27. The upper edge of the receptacle 29 nearest the outlet is rounded or provided with a support roller in order to ease pulling out of sanitary napkins 27 on the web 28 therefrom. A tension device 34 is arranged to press against the web 28 or a sanitary napkin 27 attached thereto in order to prevent the web from slacking after leaving the receptacle 29. The tension device 34 can similar to the device 20 shown in FIG. 5 or be a simple leaf spring. A separator (not shown) is preferably provided also in this embodiment and the storage roller 31 has means for preventing unwinding.

Although the dispensers have been described for the delivering of sanitary napkins or the like, they can also be constructed to contain other types of absorbent articles intended to be fastened to underclothing or other type of clothing with the aid of adhesive coating, such as baby diapers and incontinence protectors.

The described embodiments can be modified in several respects without leaving the scope of invention. For example, the dispenser can be constructed to deliver more than one size or type of sanitary napkins, i.e. rolls of winged and unwinged sanitary napkins or panty liners and sanitary napkins can be supported by the side of each other. Furthermore, the dispenser can also contain a toilet paper roll. The sanitary napkins on the web of release material can have other forms than the hour-glass form shown in FIGS. 1-4, for example rectangular form or drop form with a tapering rear part. If a skin-friendly adhesive is used the adhesive coating can be placed on the liquid permeable top sheet instead of on the backing sheet. Instead of guide rollers, fixed guide surfaces can be use to change the direction of path of the web. The dispensers can be coin operated, a step motor delivering on sanitary napkin at a time. The web can have a smaller width than the sanitary napkin as long as the adhesive coating is covered by web. In such a case it would be appropriate to put the rolls of web and absorbent articles in a transport package. The scope of invention should therefore only be restricted by the content of the enclosed patent claims.

Although only preferred embodiments are specifically illustrated and described herein, it will be appreciated that many modifications and variations of the present invention are possible in light of the above teachings and within the purview of the appended claims without departing from the spirit and intended scope of the invention.

1. A dispenser for absorbent articles containing adhesive coating on one side only, the articles being adhered in a longitudinal array to an elongate web of release material, which web is rolled or folded into a package of absorbent articles, the dispenser comprising:
a housing that includes a device for supporting the package of absorbent articles, the housing contains a device for delivering absorbent articles from the package of absorbent articles to an outlet for absorbent articles in the housing,
a device for separating absorbent articles from the web of release material, and
a device for storing the portion of web of release material, from which absorbent articles has been separated, the separating device being arranged in connection to the outlet.

2. The dispenser according to claim 1, wherein the absorbent articles include sanitary napkins, interglacial products, baby diapers or incontinence protectors.

3. A dispenser for absorbent articles containing adhesive coating on one side only, the articles being adhered in a longitudinal array to an elongate web of release material, which is rolled or folded into a package of absorbent articles the dispenser has a housing including means for supporting the package of absorbent articles, wherein the housing contains means for delivering absorbent articles from the package of absorbent articles to an outlet for absorbent articles in the housing, means for separating absorbent articles from the web of release material and means for storing the portion of web of release material, from which absorbent articles has been separated, the separating means being arranged in connection to the outlet.

4. The dispenser according to claim 3, wherein the means for delivering absorbent articles are means for unwinding of a roll of absorbent articles, the roll being formed by the web being wrapped upon itself into a roll of absorbent articles.

5. The dispenser according to claim 3, wherein means for activating the delivering means is disposed on the outside of the housing.

6. The dispenser according to claim 3, wherein the means for storage of the web of release material is a storage roller onto which the portion of web of release material, from which absorbent articles has been separated, is winded, wherewith the means for unwinding the roll of absorbent articles is means for winding up the portion of web of release material, from which absorbent articles has been separated, onto the storage roller.

7. The dispenser according to claim 6, further including means for obstructing unwinding of the storage roller.

8. The dispenser according to claim 6, wherein the means for separating absorbent articles from the web of release material comprises a web guide element changing the path of the web so that an angle is formed between the portion of the path of the web, situated between the roll of absorbent articles and the guide element, and the portion of the path of the web situated between the guide element and the storage roller, the outlet for absorbent articles being disposed in line with the direction of the path of the web of release material before reaching the web guide element.

9. The dispenser according to claim 8, wherein the angle (α) is acute.

10. The dispenser according to claim 8, wherein the web guide element is a roller.

11. The dispenser according to claim 8, further comprising a separating element disposed adjacent to the web guide element between the portion of the path of the web, situated between the guide element and the storage roller, and a plane coincidental to the direction of the path of the web of release material before reaching the web guide element.

12. The dispenser according to claim 11, wherein the separating element is a roller.

13. The dispenser according to claim 11, wherein the separating element is a blade.

14. The dispenser according to claim 11, wherein the separating element is disposed and dimensioned to pass between longitudinal stripes of adhesive coatings on the absorbent articles.

15. A roll of absorbent articles containing adhesive coating on one side only, the roll comprises an elongate web of release material to which the articles are adhered in a longitudinal array, the web being wrapped upon itself into a roll of absorbent articles for use in a dispenser according to claim 1, and the absorbent articles are absent on an outer end portion of the roll, the end portion being forward when unwinding the roll.

16. The roll according to claim 15, wherein the absorbent articles include sanitary napkins, interlabial products, baby diapers or incontinence protectors.

17. The roll according to claim 15, wherein the absorbent articles are longitudinally spaced from each other in the longitudinal array.

18. The roll according to claim 15, wherein at least the forward end of each absorbent article is free from adhesive coating.

19. A package of absorbent articles containing adhesive coating on one side only, the package comprising an elongate web of release material to which the articles are adhered in a longitudinal array, the web being zigzag folded into a package of stacked absorbent articles for use in a dispenser according to claim 1, and in that absorbent articles are absent on an outer end portion of the roll, the end portion being forward delivering absorbent articles from the package.

20. The package according to claim 19, wherein the absorbent articles include sanitary napkins, interlabial products, baby diapers or incontinence protectors.

21. The package according to claim 20, wherein the absorbent articles are longitudinally spaced a small distance from each other in the longitudinal array.

22. The package according to claim 21, wherein at least the forward end of each absorbent article is free from adhesive coating.
